(19) United States
(12) Patent Application Publication
(10) Pub. No.: US 2023/0210168 A1
(43) Pub. Date: Jul. 6, 2023

(54) DEVICE FOR INHALING A SUBSTANCE

(71) Applicant: JOOZEF, Forest (BE)

(72) Inventor: Joseph HARFOURCHE, Forest (BE)

(21) Appl. No.: 17/999,819

(22) PCT Filed: May 27, 2021
(86) PCT No.: PCT/EP2021/064176

§ 371 Date: Nov. 23, 2022

(30) Foreign Application Priority Data
May 27, 2020 (EP) 20176900.7
Feb. 3, 2021 (BE) 2021/5077

(51) Int. Cl. A24F 40/05; A24F 40/10; A24F 40/485

(52) U.S. Cl. CPC A24F 40/05; A24F 40/10; A24F 40/485

(57) ABSTRACT

A device for inhaling a substance has a cold liquid atomizer, an assembly including the atomizer and a first tank arranged to contain at least one substance to be inhaled in liquid form or in solution. The atomizer is in fluid communication with the first tank. A second tank is arranged to contain a pressurized gas and is in fluid communication with the assembly. A mouthpiece is in fluid communication with an outlet of the atomizer. A trigger is arranged to release a quantity of the gas out of the second tank and towards the assembly, and a pump is arranged to suction, inject and compress ambient air into the second tank.

The present invention relates to a device for inhaling a substance, for example to a smoking device.

These days, devices for inhaling a substance, for example smoking devices and in particular e-cigarettes, have been more and more successful as soon as smokers are more and more aware of damage caused by smoking on their health. The e-cigarette, sometimes called a vape, is an electromechanical or electronic device generating an aerosol intended to be inhaled. This aerosol or “vapour” or also “artificial smoke” looks like the smoke produced by the combustion of tobacco. This vapour (aerosol) can be flavoured (tobacco, fruit aroma, etc.) or not, and contain, or not, nicotine.

Documents US 2003/0079743, EP1917992, US 2018/0146711, US 2012/0118301 and US 2018/0343921 disclose devices for inhaling a substance.

Currently, the technology mainly commercialised for e-cigarettes is the technology of atomisation or aerosolisation consisting of the conversion of a substance in the form of sufficiently small and light particles to be transported in air, i.e. in an aerosol. In the case of a liquid, the atomisation or aerosolisation consists of the action of dispersing a liquid in fine droplets. More specifically, the technology mainly commercialised for e-cigarettes is based on the use of a heating resistance to atomise or aerosolise a liquid. In concrete terms, the principle of such an e-cigarette consists of producing an aerosol imitating tobacco smoke. The technique consists of heating a liquid (called liquid to be vaped) by way of a heating resistance: the user must trigger the heating of the resistance, the liquid heats, is vapourised and is condensed almost immediately in the form of fine droplets to produce an aerosol that the user can thus inhale. The activation of the heating of the resistance can either be manual (for example, by way of a switch), or automatic (for example, by way of an electromechanical device detecting the suctioning of the user and thus activating the resistance).

A device for inhaling a substance, for example an e-cigarette, based on the heating of a liquid is generally constituted of the following main elements: a battery (which powers the atomiser), an atomiser (which contains a resistance which will vaporise the liquid), a tank (the liquid container), and a mouthpiece which makes it possible to inhale the vapour (aerosol) exiting from the atomiser.

Other additional elements can be present, like for example an electronic power module, a voltage variator, a temperature controller, a counter of the number of puffs, means for communicating with an electronic device, like for example a computer or a smartphone, or also any other device, like a charging device.

The main element of current devices for inhaling a substance, for example current e-cigarettes, based on the heating of a liquid is the atomiser comprising a resistance which is the part having as a function, heating at high temperatures of at least 190° C. (generally between 188 and 290° C.) the liquid in order to generate the aerosol. These atomisers generally contain a resistive wire which surrounds a strand which could be, for example, made of silica fibre or cotton and/or which is surrounded by a wadding. The strand or wadding has the function of storing the liquid and of bringing it by capillarity to the resistance, such that it is heated and vapourised. When the atomiser and the cartridge are inseparable and only form one single component, the latter is called “cartomiser” or cartridge with integrated atomiser. Cartomisers supply the atomiser with liquid by way of a wadding. When the supply is ensured using a strand system, a “clearomiser” is referred to. Currently, the atomisers mainly used to perform heating are consumables, of which the service life varies enormously depending on the model, the use and the type of liquid.

Conventionally, the liquid to be heated contains the following components:
a propylene glycol (PG)- and/or vegetable glycerine (also called glycerol) (VG)-based mixture, optionally added with a combination of ethanol and/or water (<5%);
aromas, generally coming from the food industry;

and, optionally,
nicotine at variable rates, generally 0 to 3.6% (that is 0 to 36 mg/ml).

If the PG- and/or VG-based liquids are widely predominant, there are however a few alternatives. For example, propane-1,3-diol or polyethylene glycol in the form of PEG400.

Unfortunately, concerning devices for inhaling a substance, for example smoking devices and in particular; e-cigarettes, based on a heating of liquid in order to generate an aerosol, even if the vapours (aerosols) generated are, for the time being, believed as being less harmful and less toxic for the body than smoking tobacco, recent studies demonstrate that these vapours are not actually and totally harmless for the human body. Studies have even detected the presence of carcinogenic molecules in a significant quantity, like methanal, acrolein or ethanal in the vapours (aerosols) generated by e-cigarettes, but also in the body of users of such smoking devices.

To date, devices for inhaling a substance, in particular e-cigarettes, based on a heating of a liquid comprising aromatic substances are not therefore exempt of toxic products, in particular solvents and volatile organic compounds (VOC), nor potentially carcinogenic toxic compounds, such as formaldehydes-hemiacetals, acrylonitrile, acrolein, propylene oxide and acrylamide. Moreover, propylene glycol and glycerine almost systematically used for maintaining the products of the devices for inhaling a substance, in particular e-cigarettes, in liquid form, are considered as being safe at ambient temperature, but produce, once heated, potentially carcinogenic toxic compounds inhaled by the user.

Generally, devices for inhaling a substance, for example smoking devices and in particular; e-cigarettes, based on a heating of liquid in order to generate an aerosol, involve the presence of a battery, mainly for powering the heating element with electricity (generally, a resistance). Yet, any battery has a limited autonomy, this all the more so when its size and its weight are reduced in order to be able to be integrated in devices for inhaling a substance, for example in smoking devices.

Other types of devices for inhaling a substance, for example e-cigarettes, where heating is not performed in order to obtain an aerosol are known from the state of the art. Generally, devices for inhaling a substance of this type, for example smoking devices, comprise a mister- or nebuliser-type atomiser and a compressed air cartridge. If such devices for inhaling a substance, for example smoking devices, are operational, they have, despite everything, certain disadvantages, the main disadvantage of which is that once the compressed air cartridge is empty, the device for inhaling a substance is no longer operational, as long as this cartridge is not replaced.

From all of this, it emerges that, if a user does not have an energy source for charging the battery and/or a replacement compressed air cartridge, devices for inhaling a substance, for example smoking devices, are momentarily non-operational, this could prove to be particularly constraining for the user.

There is therefore a real need to provide a device for inhaling a substance, for example a smoking device “imitating” the smoke of a conventional cigarette obtained by combustion of tobacco, optimised, solving at least partially the problems mentioned above, optionally and preferably by minimising, even by removing the problem relating to the presence of carcinogenic and toxic molecules generated, among other things, by heating at high temperatures.

To address these problems, a device for inhaling a substance is provided, according to the invention, for example a smoking device, comprising:
an atomiser,
an assembly comprising said atomiser and a first tank containing at least one substance to be inhaled, said atomiser being in fluid communication with said first tank,
a second tank arranged to contain a pressurised gas and being in fluid communication with said assembly,
a mouthpiece in fluid communication with an outlet of said atomiser,
a trigger arranged to release a quantity of said gas outside of said second tank and towards said assembly, and
a pump arranged to suction the ambient air, inject it and compress it in said second tank.

In particular, to address these problems, a device for inhaling a substance is provided, according to the invention, for example a smoking device, comprising:
a cold liquid atomiser,
an assembly comprising said atomiser and a first tank arranged to contain at least one substance to be inhaled in liquid form or in solution, said atomiser being in fluid communication with said first tank,
a second tank arranged to contain a pressurised gas and being in fluid communication with said assembly,
a mouthpiece in fluid communication with an outlet of said atomiser,
a trigger arranged to release a quantity of said gas outside of said second tank and towards said assembly, and
a pump arranged to suction, inject and compress the ambient air in said second tank.

According to the invention, said first tank contains at least one substance to be inhaled in liquid form or in solution, in particular when the device for inhaling a substance according to the invention is in use.

For example, according to the invention, said pressurised gas is air or pressurised oxygen, more specifically removed (suctioned) air in the ambient environment and then injected and compressed in a tank.

By the terms “cold liquid atomiser”, an atomiser not having to heat a liquid to obtain a fine dispersion of the latter is understood, in the sense of the present invention, in particular to obtain an aerosol. In the sense of the present invention, it can, for example, be a mister or a nebuliser, in particular a cold mister or a cold nebuliser.

As soon as such a device for inhaling a substance, for example a smoking device, according to the invention is equipped with a pump arranged to suction the ambient air, inject it and compress it in said second tank, the operator can, at any moment, ensure a filling of the second tank and in it compress the air removed in the surrounding environment (ambient air). Thus, a device for inhaling a substance, for example; a smoking device, according to the invention can be operational at any moment, and does not require any replacement compressed air cartridge.

Preferably, according to the invention, the device for inhaling a substance has no battery. The absence of battery makes it possible to reduce the weight of the device for inhaling a substance according to the invention, but also makes the latter more ecological, since batteries pose serious pollution problems during their manufacture, but also for their recycling.

Preferably, according to an embodiment of the invention, an inlet of said first tank is in fluid communication with said second tank, in particular in fluid communication with an outlet of said second tank. According to this embodiment, the first tank and the second tank can be placed in series or in parallel.

Advantageously, according to the invention, said at least one substance to be inhaled in liquid form or in solution contained in said first tank is not pressurised there. According to the invention, the substance to be inhaled in liquid form or in solution contained in the first tank is driven by a released gas at the start of the second tank. Preferably, according to the invention, there is a driving of the substance to be inhaled in liquid form or in solution and not a pressurising of the substance to be inhaled in liquid form or in solution in a tank (compartment), such that it can be expelled from it.

According to the invention, preferably, the substance to be inhaled in liquid form or in solution bubbles in the gas released at the start of said second tank, the device for inhaling a substance according to the invention thus operating as a bubbler.

Advantageously, according to an embodiment of the invention, a first inlet of said cold liquid atomiser is in fluid communication with said second tank and a second inlet of said cold liquid atomiser is in fluid communication with said first tank. According to this embodiment, the pressurised gas of the second tank enters into the cold liquid atomiser through a first inlet of the latter (gas inlet) and passes through the cold liquid atomiser, which enables, for example by Venturi effect, that a substance to be inhaled in liquid form or in solution contained in the first tank enters into the cold liquid atomiser through a second inlet (inlet for substance to be inhaled) of the latter being in fluid communication with the first tank containing the substance to be inhaled in liquid form or in solution.

Preferably, according to an embodiment of the invention, said cold liquid atomiser is located at least partially in said first tank.

Optionally, according to an embodiment of the invention, said cold liquid atomiser and said first tank are mounted in parallel.

Advantageously, the device for inhaling a substance according to the invention comprises a plurality of cold liquid atomisers, in particular a plurality of cold misters or cold nebulisers, each of said cold liquid atomisers atomising one same substance to be inhaled in liquid form or in solution or each of said atomisers atomising a substance to be inhaled in liquid form or in particular solution. For example, according to the invention, the device for inhaling a substance can comprise a first cold liquid atomiser atomising a substance to be inhaled in liquid form or in solution corresponding to an aroma and a second cold liquid atomiser atomising a substance to be inhaled in liquid form or in solution corresponding to nicotine, aerosols coming from each of the cold liquid atomisers moving up by the mouthpiece.

Preferably, according to the invention, said second tank comprises a porous material, in particular a microporous material, for example a zeolite. The presence of a porous material or a microporous material makes it possible to optimise the quantity of air (of gas) injected and/or compressed in the second tank.

Advantageously, according to the invention, said pump is a manual pump. According to this embodiment, the fact that the device for inhaling a substance is equipped with a manual pump makes it possible to dispense an electrical energy source such as a battery, for example, which makes the device for inhaling a substance all the more operational at any moment. Indeed, rather than ensuring the filling of the second tank using an electrical pump, a simple manual actuation of the pump makes it possible to suction the ambient air, to inject it and to compress it in the second tank arranged to contain a pressurised gas.

In particular, according to the invention, said pump is a piston pump, like for example a bike pump.

Preferably, according to the invention, said manual pump is a two-way pump, i.e. a pump which suctions and which propels air into the second tank, not only during the back-and-forth movement, but also during the return movement of the piston of the pump. This embodiment is particularly advantageous, since a device for inhaling a substance, for example a smoking device, must be compact and it must reduce the number of movements to be made manually to ensure a pumping, such that the second tank contains rapidly enough compressed gas (air), such that the user can inhale several puffs of substance to be inhaled, thanks to the compressed air volume obtained in only a few pumps (pumping movements), preferably in only three pumps (pumping movements). Furthermore, with such a two-way pump, a more rapid and therefore more effective filling of the second tank is ensured.

Preferably, the device for inhaling a substance according to the invention comprises a two-way pump comprising several pistons, in particular several two-way pumps. This makes it possible to increase and optimise the quantity of gas (of air) suctioned and injected into the second tank during a given movement of the pump.

Preferably, the device for inhaling a substance according to the invention further comprises an additional piston other than a piston of said pump when it is manual, said additional piston being activated by the pressurised gas contained in said second tank, the pressurised gas enabling the additional piston to perform a displacement movement accompanying a movement performed by the extensor muscles of the fingers of a user during a manual pumping performed with said manual pump. This additional piston therefore facilitates the pumping by the user by increasing the force that the latter applies during a pumping using extensor muscles of their fingers.

Advantageously, according to the invention, said manual pump is equipped with an actuation means, for example a handle, in particular a handle in the form of a ring.

Advantageously, an adjustment of the distance of said actuation means of said manual pump (for example, of said handle) with respect to the body of said device for inhaling a substance (or adjustment of the opening of the handle) is possible, which makes it possible to ensure an ergonomic adaptation of any hand size. For example, the actuation means (for example, the handle) can be positioned according to at least two positions, i.e. according to two distinct distances with respect to the body of said device for inhaling a substance.

Optionally, according to the invention, the device for inhaling a substance can comprise a plurality of pumps, this in order to ensure a more rapid filling of the second tank.

Advantageously, a device for inhaling a substance according to the invention further comprises a device arranged to transform a mechanical energy into electrical energy, in particular a device arranged to transform a mechanical energy provided by a user into electrical energy, to activate the pump when the pump is manual. According to an embodiment, this electrical energy, optionally stored in a battery which would be present in the device for inhaling a substance, can be used to power a heating element such as described below. According to another embodiment, this electrical energy, optionally stored in a battery which would be present in the device for inhaling a substance, can be used to power an electrical pump, in particular an electrical pump complementary to said manual pump. As an example, such a device arranged to transform a mechanical energy into an electrical energy can be a dynamo such as, for example, present in flashlights.

Preferably, a device for inhaling a substance according to the invention further comprises a mechanism for closing said second tank, for example a one-way valve, in particular a pressure valve. According to the invention, such a mechanism for closing said second tank is arranged to prevent a gas (air) outlet at the start of the second tank when the pressure of this gas in the second tank is too low: according to the invention, the mechanism for closing said second tank, for example, a mechanical-type one-way valve (opposite force, mechanical rigidity, etc.), is triggered when the pressure within the second tank is less than a predetermined threshold value, such that the gas is no longer able to exit from the second tank. In the scope of the present invention, it has been determined that the gas (air) present in the second tank must be sufficiently compressed such that the atomisation leads to a suitable aerosol, in particular to a suitable mist or nebulisate. If the pressure of the gas in the second tank is too low, the atomisation will not be optimal: droplets of substance to be inhaled which are too large are obtained and move up to the mouth of the user in liquid form and not in the form of an aerosol (for example, a mist or a nebulisate). Advantageously, indeed, the gas (air) must be sufficiently compressed such that the atomisation can lead to droplets (particles) of a suitable size, i.e. to droplets (particles) of which the size is between 0.05 and 100 μm, preferably between 0.1 and 20 μm (D₅₀=3 μm).

Optionally, according to the invention, said mechanism for closing said second tank is associated with a pressure sensor measuring the pressure in said second tank and making it possible to control said closing mechanism.

According to an embodiment of the invention, a device for inhaling a substance according to the invention further comprises a mechanism for closing an inlet or optionally an outlet of said cold liquid atomiser. Alternatively or complementarily to the mechanism for closing said second tank, this mechanism for closing an inlet or optionally an outlet of said cold liquid atomiser also makes it possible to ensure that droplets of substance to be inhaled which are too large do not move up to the mouth of the user in liquid form, but in the form of an aerosol, for example in the form of a mist or of a nebulisate. This mechanism for closing an inlet or optionally an outlet of said cold liquid atomiser can be a valve or any other suitable device closing when the pressure at the inlet and/or at the outlet of the cold liquid atomiser is too low and leads to the formation of droplets which are too large and not to an aerosol (for example, a nebulisate or a mist) comprising (being formed by) droplets (particles) of which the size is between 0.05 and 100 μm, preferably between 0.1 and 20 μm (D₅₀=3 μm).

Advantageously, the device for inhaling a substance further comprises a pressure relief safety valve connected to the second tank, such that in case of pressure which is too high in the latter, any risk of explosion or damage of the device for inhaling a substance is avoided.

Optionally, according to an embodiment, the device for inhaling a substance further comprises a compressed air cartridge connected to the second tank and/or to the atomiser. The presence of such a compressed air cartridge constitutes an additional compressed air (gas) intake acting alone or in parallel with the second tank and/or with the atomiser.

Optionally, according to the invention, the pump can be connected to the compressed air cartridge, this in order to be able to, during the activation of the pump, supply the cartridge with compressed air (gas).

Preferably, according to the present invention, said cold liquid atomiser is a mister or a nebuliser, in particular a cold mister or a cold nebuliser.

In the sense of the present invention, said first tank contains at least one substance to be inhaled in liquid form or in solution and said second tank contains a pressurised gas.

Advantageously, when the cold liquid atomiser of a device for inhaling a substance according to the invention is a mister or a nebuliser, in particular a cold mister or a cold nebuliser, no heating must be performed in order to obtain an aerosol, smoke or a phase simulating smoke. According to an embodiment of the invention, when the cold liquid atomiser is a mister or a nebuliser, in particular a cold mister or a cold nebuliser, and that no heating is therefore performed, the aerosol (for example, the mist or the nebulisate) produced cold comprises in a lesser measure, even does not comprise any toxic and potentially carcinogenic compounds generated by heating, as is the case in a heating resistance-type atomiser encountered with current devices for inhaling a substance, in particular with current e-cigarettes, based on a heating of a liquid to obtain an aerosol.

According to an embodiment of the invention, when the cold liquid atomiser is a mister or a nebuliser, in particular a cold mister or a cold nebuliser to produce an aerosol or smoke or to simulate smoke which would; for example; be obtained with a conventional cigarette (smoke mainly produced by the combustion of tobacco), the aerosol is not generated by heating, but by cold, by way of a mister or a nebuliser, in particular a cold mister or a cold nebuliser constituting a cold liquid atomiser to lead to an aerosol in the form, for example, of a mist or of a nebulisate.

In the scope of the present invention, it has been highlighted that the aerosol exiting from the cold liquid atomiser (preferably from a cold mister or a cold nebuliser) preferably has droplets (particles) of which the size is suitable and is between 0.05 and 100 μm, preferably between 0.1 and 20 μm (D₅₀=3 μm), in order to reproduce the properties of smoke which would, for example, be obtained by combustion, this droplet size being substantially identical from one inhalation to another, and the mixture (pressurised gas+substance to be inhaled) being homogenous.

It has also been highlighted that the quantity of substance to be inhaled contained in the aerosol exiting from the cold liquid atomiser (preferably from a cold mister or from a cold nebuliser) is substantially identical from one inhalation to another.

According to the present invention, the cold liquid atomiser (for example, a cold mister or a cold nebuliser) leads to, by atomisation, an aerosol (for example, to a mist or to a nebulisate) having droplets having a droplet size between 0.05 and 100 μm, preferably between 0.1 and 20 μm, preferably between 0.25 and 10 μm, preferably between 0.5 and 5 μm.

Preferably, according to the invention, said aerosol has droplets having a droplet size distribution D₅₀ equal to 3 μm, preferably equal to 2.5 μm.

By definition, an “aerosol” is an assembly of fine, solid or liquid particles, of a substance or of a mixture of substances, in suspension/dispersion in a gaseous environment (in suspension/dispersion in a gas).

By definition, an “atomiser” is a device serving to finely disperse (to reduce into fine particles) liquids, solutions or suspensions. In the sense of the present invention, an atomiser has the function of making a substance pass from a first state to a second state which is neither liquid nor solid. In particular, in the sense of the present invention, an atomiser makes it possible to obtain an aerosol such as defined above.

Preferably, a device for inhaling a substance according to the present invention comprises a cold atomiser, in particular a cold mister or a cold nebuliser.

By definition, a “mister” is a device making it possible to perform, cold, the division of a pressurised liquid into very fine droplets to lead to a mist. A misting can, for example, be performed by spraying (reduction into fine particles) of the liquid by using an ultrasound system or a nozzle through which the liquid is fed.

By definition, a “nebuliser” makes it possible to transform liquids into a cloud of extremely fine particles (mist) and this; cold. A nebulisation can; for example; be performed by use of ultrasound, by simultaneously feeding a liquid and a gas (concentric nebuliser or Venturi nebuliser) or by pressurising a liquid and passage of the latter into a nebulisation head (for example, a hydraulic nebuliser).

Advantageously, according to the invention, a gas, a liquid or a gas/liquid mixture moving up to an inlet of said cold liquid atomiser, for example an inlet of a cold mister or of a cold nebuliser, has a velocity (speed) between 0.0025 and 50 m/s, preferably between 0.005 and 25 m/s, preferably between 0.01 and 5 m/s.

Preferably, according to the invention, a gas moving up to an inlet of said cold liquid atomiser, for example an inlet of a cold mister or of a cold nebuliser, has a flow rate between 5 and 50 Nml/s (mass flow rate).

Preferably, according to the invention, a liquid moving up to an inlet of said cold liquid atomiser, for example an inlet of a cold mister or of a cold nebuliser, has a flow rate between 0.001 and 1 ml/s, preferably between 0.1 and 0.5 ml/s.

The device for inhaling a substance according to the invention comprises a second tank comprising a pressurised gas, preferably air or oxygen or a mixture of air and pressurised oxygen.

According to the invention, said second tank comprising a pressurised gas can be a tank in the form of a removable and/or rechargeable gas cartridge.

Preferably, according to the invention, the trigger comprises a valve.

Advantageously, according to the invention, the valve of said trigger is placed between said second tank and said first tank or between said first tank and said cold liquid atomiser (for example, a cold mister or a cold nebuliser) or between said cold liquid atomiser (for example, a cold mister or a cold nebuliser) and said mouthpiece.

The trigger is preferably mounted between said second tank arranged to contain a pressurised gas and said cold liquid atomiser.

Preferably, according to the invention, the device for inhaling a substance further comprises a device or a chamber for mixing said substance to be inhaled in liquid form or in solution and of said pressurised gas. Preferably, said device or said mixture chamber is upstream from said cold liquid atomiser (for example, upstream from a cold mister or from a cold nebuliser) and is in fluid communication with an inlet of said cold liquid atomiser. Such a device or mixture chamber enables even more than a homogenous aerosol comprising the expected quantity of substance to be inhaled is formed and that the size of the droplets (particles) present in the aerosol are suitable.

Advantageously, it is provided, according to the invention, that said mouthpiece is interchangeable. It is indeed provided that different mouthpieces can be connected to a device for inhaling a substance according to the invention.

Preferably, according to the invention, said mouthpiece is rotary and makes it possible to close the tank containing the substance to be inhaled in liquid form or in solution such that the latter cannot flow outside of the device for inhaling a substance. For example, by performing a rotation movement, the mouthpiece closes the tank containing the substance to be inhaled in liquid form or in solution.

According to an embodiment of the invention, a rotation movement of said mouthpiece can make it possible to release an actuation means, for example a handle, a piston of a manual pump, when a device for inhaling a substance according to the invention comprises a manual pump to suction, inject and compress the ambient air in the second tank arranged to contain a pressurised gas.

Advantageously, according to the invention, the device for inhaling a substance further comprises a compartment comprising an aroma or an aromatic substance or nicotine. Preferably, this compartment is in fluid communication with said cold liquid atomiser (for example in fluid communication with a cold mister or a cold nebuliser). Preferably, this compartment is located downstream from the cold liquid atomiser, the aerosol formed being loaded with aroma or with aromatic substance by passage through the compartment. For example, the compartment can comprise an absorbent material which could be soaked with an aroma or an aromatic substance, or can have coated walls (coatings) of an aroma or of an aromatic substance. This compartment can be a removable and/or rechargeable element of the device for inhaling a substance according to the invention. This compartment can consist of an outer air intake (outer air inlet), wherein an aroma or an aromatic substance can be introduced by being present or not on a support. According to an embodiment of the invention, this compartment is located at the mouthpiece.

Preferably, according to the invention, said first tank and said second tank are concentric.

Preferably, according to the invention, the device for inhaling a substance further comprises a heating element, for example a resistance or a heating wall. The presence of such a heating element can make it possible to heat/temper the mixture [pressurised gas+substance to be inhaled] and/or the aerosol exiting from the cold liquid atomiser (for example, exiting from a cold mister or from a cold nebuliser) such that the user inhales an aerosol, the temperature of which can; for example; be close to that of a puff obtained with a conventional cigarette (combustion of tobacco). Such a heating element can advantageously be present at the outlet of the second tank comprising a pressurised gas to compensate for the cooling due to the expansion of the gas when it exits from said second tank. Preferably, according to the invention, such a heating element does not excessively heat the substance to be inhaled in order to avoid, even prevent any generation of toxic and/or carcinogenic molecules by heating at high temperatures.

Preferably, the device for inhaling a substance according to the invention further comprises at least one air inlet or an outer air intake. Optionally, at least one air intake is in fluid communication with the cold liquid atomiser (for example, in fluid communication with a cold mister or a cold nebuliser). According to an embodiment of the invention, an aromatic substance or aroma can be introduced into an air intake, for example by way of an element soaked with an aroma and being inserted into the air intake. For example, said at least one air inlet or an outer air intake is located at the mouthpiece, this in order to increase the volume of air to be inhaled during the use of a device for inhaling a substance according to the invention.

Preferably, the device for inhaling a substance according to the invention further comprises at least one exhaust or a safety valve, i.e. an opening on/outwards ensuring the exit of a fluid at the start of the device for inhaling a substance. This exhaust makes it possible to avoid any overpressure in the smoking device and/or any explosion of the device for inhaling a substance.

According to the invention, said at least one air intake and/or said at least one exhaust comprises a valve.

Preferably, according to the invention, the second tank comprising a pressurised gas is removable and/or rechargeable.

Preferably, according to the invention, the first tank comprising at least one substance to be inhaled in liquid form or in solution is removable and/or rechargeable.

Advantageously, according to the invention, the cold liquid atomiser, for example a cold mister or a cold nebuliser, is removable.

Preferably, according to the invention, the first tank comprising at least one substance to be inhaled in liquid form or in solution further comprises at least one additional substance chosen from the group constituted of non-toxic smoke oils, nicotine, propylene glycol, propane-1,3-diol, glycerine, ethanol, water and their mixtures. It is well understood that numerous other additional substances could be considered in the scope of the present invention.

Preferably, according to the invention, the cold liquid atomiser is a spray mister, for example a spray mister with an ultrasound system or a spray mister with a nozzle.

Advantageously, according to the invention, the cold liquid atomiser is an ultrasound nebuliser, a concentric nebuliser or a Venturi nebuliser.

Optionally, according to the invention, the device for inhaling a substance further comprises an additional cold liquid atomiser, for example a cold nebuliser or an addition cold mister.

Preferably, according to the invention, said at least one substance to be inhaled in liquid form or in solution is an aromatic substance or aroma in liquid form, in the form of an ionised liquid, or in a powder in solution in a solvent. Any other suitable form of said at least one substance to be inhaled in liquid form or in solution also forms the subject of the present invention. According to an embodiment of the invention, said substance to be inhaled in liquid form can simply be water, optionally distilled water.

Preferably, the substance to be inhaled in liquid form or in solution is not in oil or viscous or semi-viscous phase, but only in aqueous phase or in a non-oil, non-viscous or non-semi-viscous solvent.

According to an embodiment, the device for inhaling a substance according to the invention, further comprises at least one additional element chosen from the group constituted of valves, a battery, a suction detector or pressure sensor, an electronic power module, a voltage variator, a temperature controller, a counter of the number of puffs, means for communicating with an electronic device like a computer or a smartphone, a switch controlling said trigger, a mixer, for example a Venturi-type mixer.

According to the invention, the device for inhaling a substance can also comprise an electronic module for programming the quantity of substance to be inhaled at each puff and/or the volume of gas released at each puff and/or the temperature of the heating element.

Preferably, according to the invention, the trigger is a mechanical trigger, for example a non-return valve, or an electromechanical trigger, for example a solenoid valve. According to the invention, the trigger, for example a trigger in the form of a (solenoid) valve, can be located either between the first tank comprising at least one substance to be inhaled in liquid form or in solution and the second tank comprising a pressurised gas, or between the second tank comprising a pressurised gas and the cold liquid atomiser (for example, a cold mister or a cold nebuliser), or between the cold liquid atomiser and the mouthpiece.

The trigger can be a non-return valve-type mechanical trigger. When the user exerts a suctioning at the mouthpiece, the non-return valve constituting the trigger and comprising a return spring passes from a rest position, where it is abutted against an abutment at a work position (the non-return valve is no longer held against the abutment). The return spring is arranged such that it exerts a sufficient force to hold the non-return valve in its rest position when the device for inhaling a substance is not used. The suctioning exerted by the user at the mouthpiece has the effect of shifting the non-return valve in the direction of the user, to create a depression in the device for inhaling a substance and, due to this, to enable a certain quantity of gas contained in the second tank to move up to the first tank comprising the substance to be inhaled in liquid form or in solution to transport (push) it towards the cold liquid atomiser (for example, a cold mister or a cold nebuliser). The passage of the substance to be inhaled in the cold liquid atomiser leads to a formation of an aerosol comprising the substance to be inhaled in the form of fine droplets simulating, for example, smoke which would be obtained with a conventional cigarette (smoke mainly produced by the combustion of tobacco).

Preferably, the device for inhaling a substance according to the invention comprises a turbine to increase the airflow during a suctioning performed by the user.

According to an embodiment of the invention, the device for inhaling a substance comprises a battery, which can power a compressor and/or a pump to compress a gas in said second tank.

Advantageously, according to an embodiment of the invention, the device for inhaling a substance comprises a stop valve located upstream from said cold liquid atomiser, said stop valve comprising a second inlet and a second outlet, the second inlet being connected by a first fluid connection to an outlet of said second tank arranged to contain a pressurised gas and the second outlet being connected by a second fluid connection to a first inlet of said cold liquid atomiser, said stop valve being configured to be closed as long as a pressure P₁ of said pressurised gas at said second inlet is less than a reference minimum pressure Pₘᵢₙ and being configured to open when and as long as said pressure P₁ of said pressurised gas at said second inlet is greater than or equal to the pressure Pₘᵢₙ.

Preferably, according to the invention, said pressure Pₘᵢₙ is between 0.1 and 1 bar, more specifically between 0.2 and 0.7 bar, more preferably still between 0.3 and 0.4 bar.

The presence of such a stop valve makes it possible to ensure that the pressure of the gas at the inlet of said cold liquid atomiser is always equal to or greater than [Pₘᵢₙ−PC] (PC being the charge losses between the second outlet and the first inlet) when the cold liquid atomiser receives gas coming from the second tank. This, in particular, makes it possible to form an aerosol (in particular, a mist or a nebulisate) having particles (drops/droplets) of sufficiently reduced size to simulate smoke, for example particles having a diameter less than 100 μm, preferably particles of size between 0.05 and 100 μm, preferably particles of size between 0.1 and 20 μm (D₅₀=3 μm). The stop valve therefore has the function of ensuring that the cold liquid atomiser always operates with a sufficient inlet pressure. Indeed, if the inlet pressure of the cold liquid atomiser is too low, the cold liquid atomiser is no longer able to ensure the obtaining of an aerosol simulating smoke, but leads to particles which are too large (particles having, for example, a diameter greater than 100 μm) and to “sputtering”.

Preferably, according to an embodiment of the invention, the device for inhaling a substance further comprises a safety valve comprising an inlet fluidically connected to the second tank arranged to contain a pressurised gas and an outlet in fluid communication with an outer surrounding environment, said safety valve being configured to be and remain closed as long as a pressure Pᵢₙ at its outlet is less than a predetermined safety pressure P_{sécurité} and being configured to open when and as long as said pressure Pᵢₙ at its inlet is greater than the predetermined safety pressure P_{sécurité}.

Preferably, the inlet of the safety valve is fluidically connected directly to a wall or to an outlet of said second tank arranged to contain a pressurised gas.

Preferably, according to the invention, said predetermined safety pressure P_{sécurité} is between 5 and 20 bar, more preferably between 10 and 12 bar.

Preferably, according to the invention, said predetermined safety pressure P_{sécurité} is not greater than 20 bar.

The presence of such a safety valve makes it possible to reduce the risk of explosion of all or some of the device according to the invention.

Advantageously, according to an embodiment of the invention, the device for inhaling a substance further comprises a pressure regulator located between said second tank arranged to contain a pressurised gas and said cold liquid atomiser. A pressure regulator such as is known from the state of the art and is a device which limits the pressure at its outlet to a reference maximum pressure Pₘₐₓ.

The presence of such a pressure regulator makes it possible to obtain puffs of a longer duration than in the absence of such a regulator, this for one same pumping energy implemented by a user in order to compress gas (air) in the second tank.

Preferably, according to the invention, said predetermined reference maximum pressure Pₘₐₓ is between 0.3 and 2 bar, preferably between 0.5 and 1 bar, more preferably between 0.6 and 0.7 bar.

In any case, the reference minimum pressure Pₘᵢₙ is less than the reference maximum pressure Pₘₐₓ.

Advantageously, according to an embodiment of the invention, when the device for inhaling a substance comprises a stop valve, said pressure regulator is located upstream from the stop valve. According to this preferred embodiment, said pressure regulator has, for example, a third inlet connected by a third fluid connection to an outlet of said second tank arranged to contain a pressurised gas and a third outlet connected by a fourth fluid connection to the second inlet of said stop valve.

According to a particular embodiment of the invention, said stop valve and/or said pressure regulator and/or said safety valve are located in said second tank arranged to contain a pressurised gas.

The present invention also relates to an assembly comprising a device for inhaling a substance according to the invention and a docking station of said second gas tank, in particular air, and/or charging with electrical energy of the device for inhaling a substance.

The present invention also relates to a use of a device for inhaling a substance according to the invention to atomise (for example, to mist or nebulise) at least one substance to be inhaled.

These aspects, as well as other aspects of the invention will be clarified in the detailed description of particular embodiments of the invention, reference being made to the drawings of the figures, wherein:

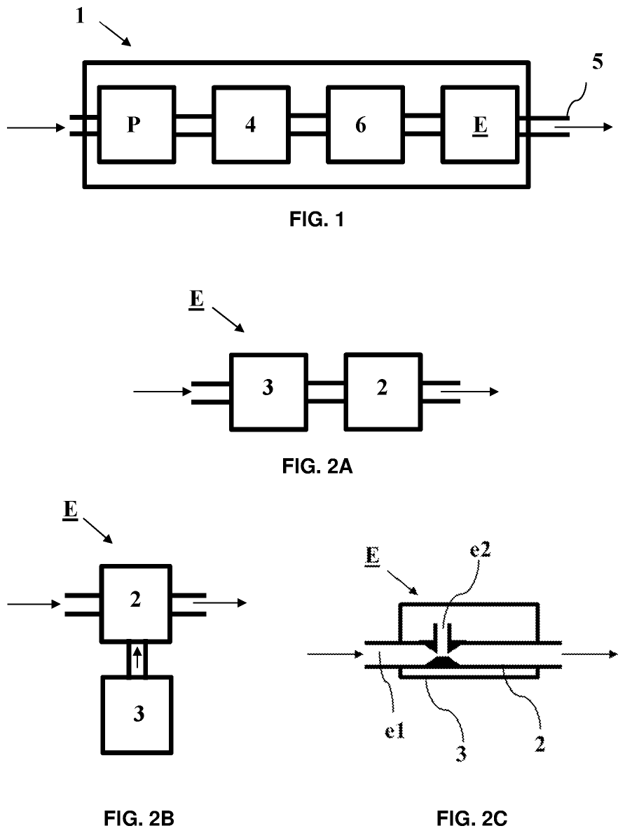

FIG. 1 is a schematic view of an embodiment of a device for inhaling a substance according to the invention.

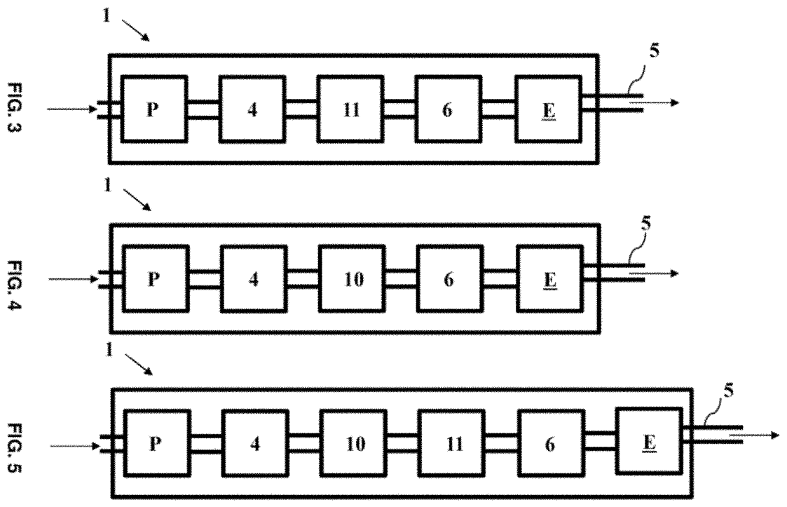

FIG. 2A illustrates an embodiment of an assembly E according to the invention comprising a cold liquid atomiser and a first tank containing at least one substance to be inhaled in liquid form or in solution.

FIGS. 2B and C illustrate another embodiment of an assembly E according to the invention comprising a cold liquid atomiser and a first tank containing at least one substance to be inhaled in liquid form or in solution.

FIG. 3 is a schematic view of another embodiment of a device for inhaling a substance according to the invention comprising a stop valve.

FIG. 4 is a schematic view of another embodiment of a device for inhaling a substance according to the invention comprising a pressure regulator.

FIG. 5 is a schematic view of another embodiment of a device for inhaling a substance according to the invention comprising a stop valve and a pressure regulator.

FIG. 6 is a schematic, cross-sectional view of an example of a stop valve.

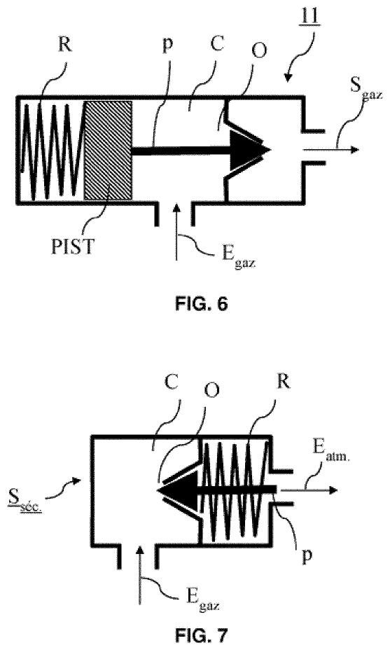

FIG. 7 is a schematic, cross-sectional view of an example of a safety valve.

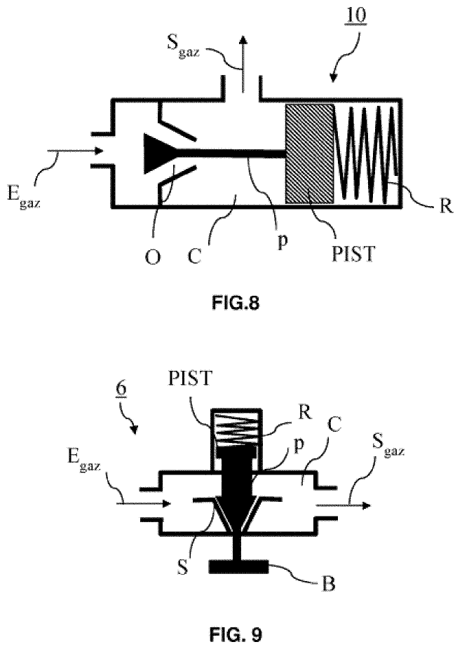

FIG. 8 is a schematic, cross-sectional view of an example of a pressure regulator.

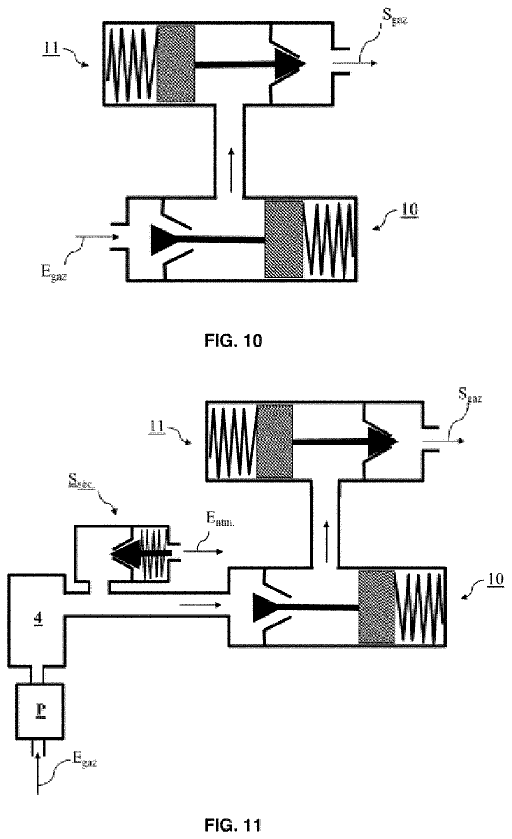

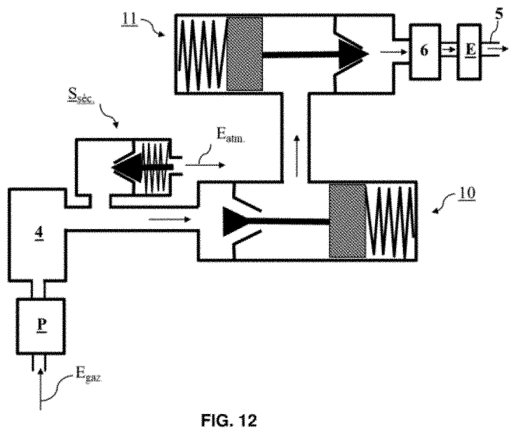

FIG. 9 is a schematic, cross-sectional view of an example of a trigger.

FIG. 10 is a schematic, cross-sectional view of an example of an association of a pressure regulator and a stop valve.

FIG. 11 is a schematic, cross-sectional view of an example of an association of a pressure regulator, a stop valve and a safety valve.

FIG. 12 is a schematic, cross-sectional view of an example of a device for inhaling a substance according to the invention.

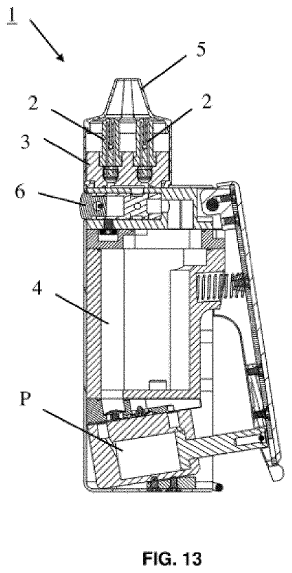

FIG. 13 is a schematic, cross-sectional view of another embodiment of a device for inhaling a substance according to the invention.

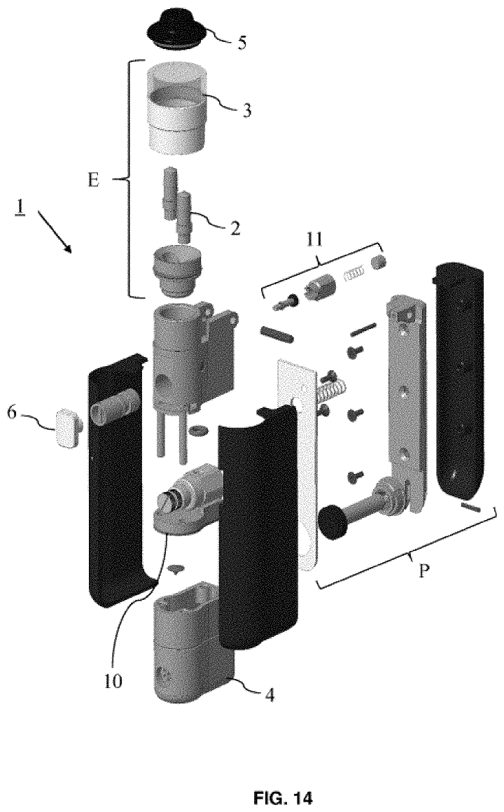

FIG. 14 is a schematic, exploded view of another embodiment of a device for inhaling a substance according to the invention.

Generally, similar or identical elements are referenced by identical references in the figures. The drawings of the figures are not to scale, nor proportioned.

FIG. 1 illustrates an embodiment of a device for inhaling a substance according to the invention. According to this embodiment, the device for inhaling a substance 1 comprises:
a cold liquid atomiser, for example a cold mister or a cold nebuliser,
an assembly E comprising said cold liquid atomiser and a first tank containing at least one substance to be inhaled in liquid form or in solution, said atomiser being in fluid communication with said first tank,
a second tank 4 comprising a pressurised gas and being in fluid communication with said assembly E,
a mouthpiece 5 of which an inlet is in fluid communication with an outlet of said atomiser and of which an outlet is free,
a trigger 6 arranged to release a quantity of said gas outside of said second tank 4 and towards said assembly E, and
a pump P arranged to suction the ambient air, inject it and compress it in said second tank 4.

According to this embodiment, said first tank comprises a fluid inlet in fluid communication with an outlet of said second tank 4 comprising a pressurised gas. Furthermore, the device for inhaling a substance 1 comprises a trigger 6. According to a first example, the trigger 6 can be a valve which can be opened by a pushbutton or any other equivalent means which is accessible by the user. According to a second example, the trigger 6 can be a solenoid valve and comprise a suctioning detector or pressure sensor (not illustrated), a control unit (not illustrated) connected to the pressure sensor and an electrical source (for example, a battery) (not illustrated). According to this second example, when the user exerts a suctioning at the mouthpiece 5, the control unit will measure a depression in the device 1 via the pressure sensor and thus enable the passage of a current towards the solenoid valve (which constitutes the trigger 6) such that the latter passes from a rest position according to which it is closed at a work position according to which it is open. Since the second tank 4 comprises a pressurised gas and that it is in fluid communication with said first tank which is itself in fluid communication with an inlet of the cold liquid atomiser which is itself in fluid communication with the mouthpiece 5, the opening of the solenoid valve creating a depression in the device 1 will lead to a release of gas at the start of the second tank 4, the gas thus driving the substance to be inhaled in liquid form or in solution contained in the first tank towards an inlet of the cold liquid atomiser. Such a driving of the substance to be inhaled in liquid form or in solution by a gas facilitates the passage of the latter in the atomiser, but also the outlet of the aerosol obtained by the mouthpiece 5, which makes the use of this embodiment according to the invention all the more comfortable for the user. The passage of the substance to be inhaled in liquid form or in solution in the atomiser leads to an atomisation such that an aerosol is formed (for example, in the form of a mist or of a nebulisate) comprising the substance to be inhaled in the form of fine droplets and simulating smoke which would, for example, be obtained with a conventional cigarette (smoke mainly produced by the combustion of tobacco).

FIG. 2A illustrates an embodiment of an assembly E according to the invention comprising a cold liquid atomiser 2 and a first tank 3 containing at least one substance to be inhaled in liquid form or in solution, said atomiser 2 being in fluid communication with said first tank 3.

FIGS. 2B and 2C illustrate another embodiment of an assembly E according to the invention comprising a cold liquid atomiser 2 and a first tank 3 containing at least one substance to be inhaled in liquid form or in solution. According to this embodiment illustrated in FIG. 2C, the cold liquid atomiser 2 is partially present in the first tank 3. More specifically, according to this embodiment, a first inlet e1 (gas inlet) of the cold liquid atomiser 2 is in fluid communication with an outlet of the second tank 4 and a second inlet e2 (inlet for substance to be inhaled in liquid form or in solution) of the cold liquid atomiser 2 is in fluid communication with the first tank 3 containing the substance to be inhaled in liquid form or in solution. For example, according to this embodiment, the substance to be inhaled in liquid form or in solution moves up to the cold liquid atomiser 2 by Venturi effect, which is due to the passage of the pressurised gas through the cold liquid atomiser 2, which implies that the substance to be inhaled in liquid form or in solution is “suctioned” and moves up to the cold liquid atomiser 2 through the inlet e2.

FIG. 3 illustrates another embodiment of a device for inhaling a substance 1 according to the invention. This embodiment comprises the same components as those illustrated in FIG. 1 and a stop valve 11 located upstream from the assembly E comprising a cold liquid atomiser and a first tank containing at least one substance to be inhaled in liquid form or in solution, said cold liquid atomiser being in fluid communication with said first tank, said stop valve 11 comprising a second inlet and a second outlet, the second inlet being connected by a first fluid connection to an outlet of said second tank 4 arranged to contain a pressurised gas and the second outlet being connected by a second fluid connection to a first inlet of said cold liquid atomiser, said stop valve 11 being configured to be and remain closed as long as a pressure P₁ of said pressurised gas at said second inlet is less than a reference minimum pressure Pₘᵢₙ and being configured to open when and as long as said pressure P₁ of said pressurised gas at said second inlet is greater than or equal to the pressure Pₘᵢₙ.

FIG. 4 illustrates another embodiment of a device for inhaling a substance 1 according to the invention. This embodiment comprises the same components as those illustrated in FIG. 1 and a pressure regulator 10 located between said second tank 4 arranged to contain a pressurised gas and the assembly E comprising a cold liquid atomiser and a first tank containing at least one substance to be inhaled in liquid form or in solution, said atomiser being in fluid communication with said first tank.

FIG. 5 illustrates another embodiment of a device for inhaling a substance 1 according to the invention. This embodiment comprises the same components as those illustrated in FIG. 1 and simultaneously a pressure regulator 10 and a stop valve 11, said pressure regulator 10 and said stop valve 11 being located upstream from the assembly E comprising a cold liquid atomiser and a first tank containing at least one substance to be inhaled in liquid form or in solution, said atomiser being in fluid communication with said first tank.

FIG. 6 is a schematic, cross-sectional view of an example of a stop valve 11. This stop valve 11 comprises a chamber C having a gas inlet E_{gaz}, a gas outlet S_{gaz}, an orifice O and a piston PIST to which a needle p is connected, designed to engage with the orifice O. In the absence of pressure at the gas inlet E_{gaz}, the needle p is held abutted against the orifice O and thus closes this orifice O thanks to the force exerted on the piston PIST by an extended pre-tensed spring R. This closed position is held as long as a gas pressure at the gas inlet E_{gaz} is less than a reference minimum pressure Pₘᵢₙ. When the gas pressure at the gas inlet E_{gaz} becomes greater than the reference pressure Pₘᵢₙ, the piston PIST will move leftwards by compressing the spring R such that the needle p no longer blocks the orifice O, the stop valve 11 thus being open and letting the gas pass from its inlet E_{gaz} to its outlet S_{gaz}.

FIG. 7 is a schematic, cross-sectional view of an example of a safety valve S_{séc}. This safety valve S_{séc} comprises a chamber C having a gas inlet E_{gaz}, an exhaust towards the atmosphere Eₐₜₘ, an orifice O and a needle p designed to engage with the orifice O. The chamber C includes an extended pre-tensed spring R to which the needle p is connected. In the absence of pressure at the gas inlet E_{gaz}, the needle p is held abutted against the orifice O and thus closes this orifice O, thanks to the force exerted by the extended pre-tensed spring R. This closed position is held as long as a pressure at the gas inlet E_{gaz} is less than a predetermined safety pressure P_{sécurité}. The stop valve will pass into the open position as soon as the pressure at the gas inlet E_{gaz} is greater than the predetermined safety pressure P_{sécurité}, the safety valve S_{séc} thus being open and letting the gas pass from its inlet E_{gaz} to the exhaust towards the atmosphere Eₐₜₘ.

FIG. 8 is a schematic, cross-sectional view of an example of a pressure regulator 10. This pressure regulator 10 comprises a chamber C having a gas inlet E_{gaz}, an orifice O and a piston PIST to which a needle p is connected, designed to engage with the orifice O. In the absence of pressure at the gas inlet E_{gaz}, the needle p is held at a distance from the orifice O and thus leaves this orifice O open, thanks to the force exerted on the piston PIST by an extended pre-tensed spring R. This open position is held as long as a gas pressure at the gas inlet E_{gaz} is less than or equal to a reference maximum pressure Pₘₐₓ. When the gas pressure at the gas inlet E_{gaz} becomes greater than the reference maximum pressure Pₘₐₓ, the piston PIST will move rightwards by compressing the spring R such that the needle p will block the orifice O, the stop valve 11 thus being closed and no longer letting the gas pass from its inlet E_{gaz} to its outlet S_{gaz}.

FIG. 9 is a schematic, cross-sectional view of an example of a trigger 6. This trigger 6 comprises a chamber C having a gas inlet E_{gaz}, a gas outlet S_{gaz}, a seat S and a piston PIST to which a needle p is connected, designed to engage with the seat S. The needle p is extended outwards from the chamber to end by a button B. In the absence of action on the button B, the needle p is held abutted against the seat S and thus closes the passage to gases, thanks to the force exerted on the piston PIST by an extended pre-tensed spring R. To pass to an open position and therefore to enable a passage of gas from the inlet E_{gaz} to the outlet S_{gaz}, a pressure must be exerted by a user on the button B, so as to compress the spring R and to shift the needle p such that it is no longer abutted against the seat S.

FIG. 10 is a schematic, cross-sectional view of an example of an association of a pressure regulator 10 and a stop valve 11 such as described above. According to this embodiment, the pressure regulator 10 is positioned upstream from the stop valve 11 and in series with the stop valve.

FIG. 11 is a schematic, cross-sectional view of an example of an association of a pressure regulator, a stop valve and a safety valve such as described above. According to this embodiment, the safety valve is positioned upstream from the pressure regulator, preferably between the second tank 4 and an outlet of the pump P. Preferably, the safety valve is mounted directly on or even in the second tank 4.

FIG. 12 is a schematic, cross-sectional view of an example of a device for inhaling a substance according to the invention. According to this embodiment, a pump P is fluidically connected to a second tank 4 arranged to contain a pressurised gas and being positioned upstream from a pressure regulator 10 to which it is fluidically connected. A safety valve S_{séc} is positioned upstream from a stop valve 11 to which it is fluidically connected. An outlet of the stop valve 11 is fluidically connected to an assembly E comprising a cold liquid atomiser and a first tank containing at least one substance to be inhaled in liquid form or in solution, said atomiser being in fluid communication with said first tank. According to this embodiment, a trigger 6 is positioned between the assembly E and said stop valve 11.

Preferably, the chamber C comprises an opening (not represented in the figures) on the spring side of the piston PIST in order to let the ambient air enter into the chamber 6 on this side of the piston PIST.

FIG. 13 is a schematic, cross-sectional view of another embodiment of a device for inhaling a substance according to the invention.

FIG. 14 is a schematic, exploded view of another embodiment of a device for inhaling a substance according to the invention.

The present invention has been described relative to specific embodiments, which have a purely illustrative value and must not be considered as limiting. Generally, it will appear obvious for a person skilled in the art that the present invention is not limited to the examples illustrated and/or described above.

The use of the verbs “comprise”, “include”, “have”, or any other variant, as well as their conjugations, cannot in any way, exclude the presence of elements other than those mentioned.

The use of the indefinite article “a” or “an”, or of the definite article “the”, to introduce an element does not exclude the presence of a plurality of these elements.

1-24. (canceled)

25. A device for inhaling a substance comprising:
a cold liquid atomizer;
an assembly comprising said atomizer and a first tank arranged to contain at least one substance to be inhaled in liquid form or in solution, said atomizer being in fluid communication with said first tank;
a second tank arranged to contain a pressurised gas and being in fluid communication with said assembly;
a mouthpiece in fluid communication with an outlet of said atomizer;
a trigger arranged to release a quantity of said gas outside of said second tank and towards said assembly; and
a pump arranged to suction, inject, and compress ambient air in said second tank.

26. The device for inhaling a substance according to claim 25, wherein an inlet of said first tank is in fluid communication with said second tank.

27. The device for inhaling a substance according to claim 25, wherein a first inlet of said cold liquid atomizer is in fluid communication with said second tank, and wherein a second inlet of said cold liquid atomizer is in fluid communication with said first tank.

28. The device for inhaling a substance according to claim 27, wherein said cold liquid atomizer is located at least partially in said first tank.

29. The device for inhaling a substance according to claim 25, wherein said pump is a manual pump.

30. The device for inhaling a substance according to claim 29, wherein said manual pump is a two-way pump.

31. The device for inhaling a substance according to claim 29, further comprising an additional piston other than a piston of said pump when said pump is a manual pump, said additional piston being activated by a pressurised gas contained in said second tank, the pressurised gas enabling the additional piston to perform a displacement movement accompanying a movement performed by extensor muscles of a user during a manual pumping performed with said manual pump.

32. The device for inhaling a substance according to claim 29, further comprising a device arranged to transform mechanical energy into electrical energy.

33. The device for inhaling a substance according to claim 25, further comprising a compartment comprising an aroma or an aromatic substance and being in fluid communication with said cold liquid atomizer.

34. The device for inhaling a substance according to claim 25, comprising a stop valve located upstream from said cold liquid atomizer, said stop valve comprising a second inlet and a second outlet, the second inlet being connected by a first fluid connection to an outlet of said second tank arranged to contain a pressurized gas and the second outlet being connected by a second fluid connection to a first inlet of said cold liquid atomizer, said stop valve being configured to be and remain closed as long as a pressure of said pressurised gas at said second inlet is less than a reference minimum pressure and being configured to open when and as long as said pressure of said pressurised gas at said second inlet is greater than or equal to the reference minimum pressure.

35. The device for inhaling a substance according to claim 25, comprising a safety valve comprising an inlet fluidically connected to the second tank arranged to contain a pressurised gas, and an outlet in fluid communication with an outer surrounding environment, said safety valve being configured to be and remain closed as long as an inlet pressure at the inlet of the safety valve is less than a predetermined safety pressure and being configured to open when and as long as said inlet pressure at the inlet of the safety valve is greater than the predetermined safety pressure.

36. The device for inhaling a substance according to claim 25, comprising a pressure regulator located between said second tank arranged to contain a pressurised gas and said cold liquid atomizer.

37. The device for inhaling a substance according to claim 25, wherein the device is free of a battery.

38. An assembly comprising a device for inhaling a substance according to claim 25 and a station for filling said second tank with gas.

39. A method of using a device for inhaling a substance according to claim 25, the method comprising atomizing at least one substance to be inhaled.

40. The device for inhaling a substance according to claim 29, further comprising a device arranged to transform mechanical energy provided by a user into electrical energy to activate the pump when the pump is a manual pump.

41. An assembly comprising a device for inhaling a substance according to claim 25, and a station for filling said second tank with air and/or recharging the device for inhaling a substance with electrical energy.
